(19) United States
(12) Patent Application Publication
(10) Pub. No.: US 2003/0158959 A1
(43) Pub. Date: Aug. 21, 2003

(54) Establishment of communications using point to point protocols such that duplicate negotiations are avoided

(76) Inventors: Jay Jayapalan, Buffalo Grove, IL (US); Mohammed E. Qasim, Geneva, IL (US); Shreesha Ramanna, Wheeling, IL (US)

Correspondence Address: VEDDER PRICE KAUFMAN & KAMMHOLZ, 222 N. LASALLE STREET, CHICAGO, IL, 60601, US

(21) Appl. No.: 10/077,407

(22) Filed: Feb. 15, 2002

(51) Int. Cl. G06F 15/16; H04L 12/28; H04L 12/56

(52) U.S. Cl. 709/237; 370/389

(57) ABSTRACT

A network element (204) acting as an intermediary between two peers (202, 206) monitors for control messages exchanged between the two peers when establishing a point to point protocol session. Relevant parameters within such control messages are stored (612) for later use. When retransmitted control messages are detected (610), the network element processes the retransmitted control message based on the stored parameters (618) such that additional negotiation loops are avoided. In this manner, the effects of non-simultaneous link establishment and differing timeout timers are mitigated by the network element.

### TECHNICAL FIELD

The present invention relates generally to wireless communication systems and, in particular, to a technique for establishing communications based on point to point protocols within such systems that avoids duplicate negotiations.

### BACKGROUND OF THE INVENTION

Wireless communication systems are well known in the art. Such systems typically comprise a plurality of mobile subscribers (MSs) or communication units in wireless communication with an infrastructure. As known in the art, a point to point protocol (PPP) is typically used to establish communication between two peers. Typically, a peer is implemented as a logical process executed by a physical platform which the peer represents. Once peer to peer communication is established, data may be transferred between the communication units and another device implementing a destination peer within the infrastructure via one or more intermediate network elements. An illustration of this is provided in FIG. 1.

In particular, FIG. 1 illustrates protocol stacks in accordance with the so-called Open System Interconnect (OSI) model. As shown, protocol stacks for a communication unit (on the left), a network element (middle), and an interworking unit (IWU) (on the right) are shown. As known in the art, individual layers within protocol stacks are logically, if not physically, terminated within corresponding levels of other protocol stacks. For example, between the network element and the IWU, a physical layer 102 is provided. Likewise, between the network element and the communication unit, a different physical layer protocol is implemented, in particular, the so-called IS95/IS2000 protocol. Other protocol layers known to those having ordinary skill in the art are also illustrated in FIG. 1. In particular, a PPP layer 110 is terminated by the communication unit and the IWU. Note that while the network element actively translates lower levels of the protocol stacks, it transparently passes data concerning the PPP layer 110 as indicated by the heavy arrow. Successively higher layers of each protocol stack at the communication unit and IWU build upon the PPP layer. For example, an Internet Protocol (IP) layer 112 and other higher layers 114 exchange information via the point to point protocol layer 110.

As known in the art, when a PPP connection is established, the respective peers engage in a time-sensitive negotiation of link parameters before data may be transferred. An example of optimal negotiations is illustrated in FIG. 2. As shown therein, a communication unit 202 communicates with an IWU 206 via one or more network elements 204. Note that, in FIG. 2, the progression of time is illustrated from top to bottom. In an ideal scenario, a communication link between the communication unit 202 and network element 204, as well as a communication link between the IWU 206 and network element 204 are established substantially simultaneously as shown by the heavy arrows in FIG. 2. Thereafter, the negotiations comprise the transmission by each peer of a configuration request message (REQ) followed by the timely transmissions of acknowledgement messages (ACK) as shown in FIG. 2. In this context, the acknowledgements are timely sent if they are received by their respective targets prior to the expiration of a timeout timer initiated after the request messages have been sent. An exemplary timeout timer 208 is schematically illustrated in FIG. 2. In this case, the timeout timer 208 is initiated by the communication unit 202 shortly after it transmits a configuration request to the IWU 206. If the acknowledgement transmitted by the IWU to the communication unit is received by the communication unit prior to the expiration of the timeout timer 208, the negotiation has been successfully completed relative to the communication unit. A similar process applies to the IWU 206 based on its own timeout timer (not shown). If a given peer does not receive an acknowledgement prior to expiration of its timeout timer, it attempts to restart negotiations by retransmitting its configuration request. Traditionally, PPP is used in a wireline environment where link establishment is performed between peers after the physical connection is fully established, and the likelihood of any impact due to differing timeout timers between peers is relatively low.

However, in real world implementations of wireless systems, the links between the peers and the network elements are not always established substantially simultaneously. As a result, the timing of the request/acknowledgement exchange may be disrupted to the point that additional, often times multiple, negotiation loops must take place. Additionally, different peers within the communication system may be configured with timeout timers of different durations. As a result, the sometimes unpredictable delays incurred by transmission of the requests and/or acknowledgements across the intermediate network may result in failed negotiations where a given timeout timer is not configured to accommodate such delays. Again, the result of this is typically one or more negotiation loops. The occurrence of such negotiation loops, in turn, adversely affects the setup time needed to establish the communications between the peers. Inasmuch as the overall quality of the communication system is in part judged by the speed with which communications are established, the occurrence of multiple negotiations leads to poor perceived quality by a communication system's users. Thus, it would be advantageous to provide a technique whereby duplicate negotiations when establishing PPP communications are substantially avoided.

### BRIEF DESCRIPTION OF THE DRAWINGS

FIG. 1 is a schematic illustration of relationships between protocol stacks within various elements of a communication system in accordance with the prior art.

FIG. 2 is a timing diagram illustrating optimal negotiations of a point to point protocol.

FIG. 3 is a block diagram of a wireless communication system in accordance with the present invention.

FIG. 4 is a timing diagram illustrating the occurrence of duplicate negotiations resulting from the non-simultaneous establishment of communication links.

FIG. 5 is a timing diagram illustrating the occurrence of duplicate negotiations as a result of differing timeout timers.

FIG. 6 is a flowchart illustrating a method for avoiding duplicate negotiations when establishing peer to peer communications in accordance with the present invention.

FIGS. 7 and 8 are timing diagrams illustrating alternative embodiments of operation of the present invention.

### DETAILED DESCRIPTION OF THE INVENTION

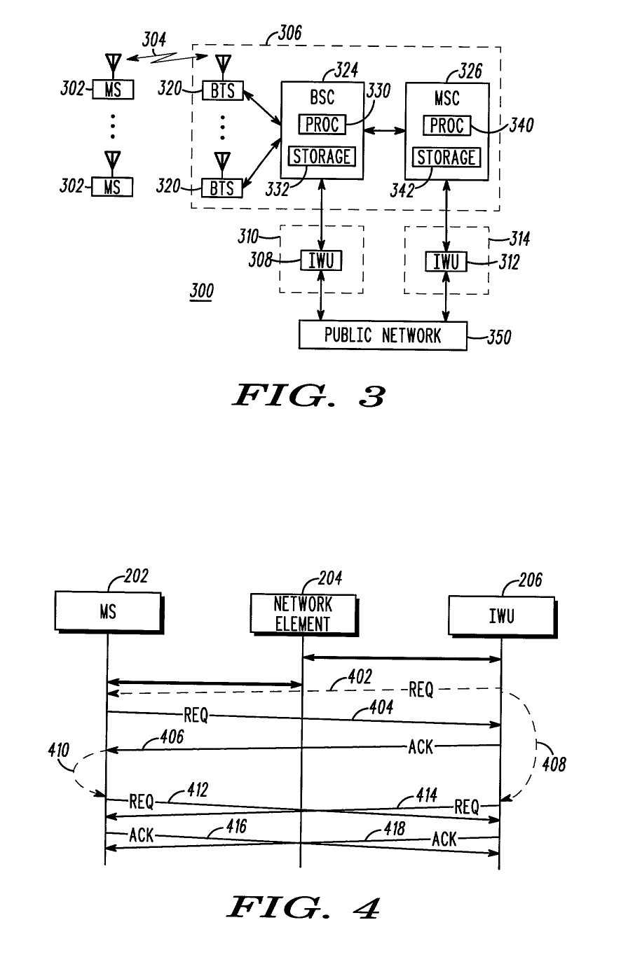

The present invention provides a technique for establishing a PPP session such that duplicate negotiation loops are substantially avoided despite the occurrence of non-simultaneous link establishment or differing timeout timers. To this end, a network element acting as an intermediary between two peers monitors messages exchanged between the two peers. Control messages between the peers are identified and monitored and the relevant parameters within such control messages are stored for later use. The monitoring of the control or data messages does not prevent the messages from being forwarded to their original destination. Thereafter, when the network element detects a retransmission of a control message, it processes the retransmitted control message based on the stored parameters such that the occurrence of additional negotiation loops is avoided. In a presently preferred embodiment, the peers may comprise a communication unit and an interworking unit. Additionally, in another embodiment of the present invention, the processing performed by the network element to avoid the duplicate negotiation loops includes discarding the retransmission of the control message and optionally, sending an acknowledgement of the retransmission of the control message to the peer that initiated the retransmission. In this manner, the effects of non-simultaneous link establishment and differing timeout timers are mitigated by the network element. The present invention may be more readily described with further reference to FIGS. 3-8.

Referring now to FIG. 3, a wireless communication system 300 in accordance with the present invention is illustrated. In particular, the system 300 comprises a plurality of mobile subscribers or communication units 302 in communication with an intermediate wireless network 306 via wireless resources 304. For any given call, the intermediate network 306 is in communication with either a packet network 310 or a circuit network 314 which, in turn, may be connected to a public network 350, such as the Internet or World Wide Web. The communication system 300 illustrated in FIG. 3 is typically found in code-division multiple access (CDMA) systems today. However, the present invention is not limited in its application to such CDMA systems, but may be beneficially applied to any wireless communication system in which a PPP is used to establish communications between a wireless peer and an infrastructure based peer.

The communication units 302 may comprise virtually any wireless device, but in a preferred embodiment comprise mobile and/or portable devices such as in-car two-way radios or handheld radio telephones. Regardless, the communication units 302 communicate with the intermediate network 306 via wireless resources 304. In a presently preferred embodiment, the wireless resources 304 comprise RF channels implementing CDMA protocols. However, the present invention is not limited in this regard and the wireless resources 304 may comprise other types of wireless channels implementing other types of access protocols as known in the art, such as frequency division multiple access (FDMA) or time division multiple access (TDMA) protocols.

The intermediate network 306 comprises a wireless front end of base transceiver systems 320 coupled to one or more base station controllers 324. In turn, each base station controller 324 is coupled to a mobile switching center 326 as known in the art. The configuration and operation of base transceiver systems 320, base station controllers 324 and mobile switching centers 326 are well known in the art and need not be described in greater detail here. As further illustrated in FIG. 3, the base station controller 324 and mobile switching center 326 each comprise one or more processors 330, 340 coupled to respective storage devices 332, 342. The processors 330, 340 may each comprise one or more microprocessors, microcontrollers, digital signal processors, combinations thereof or other such devices known to those having ordinary skill in the art. Likewise, the storage devices 332, 342 may each comprise volatile and non-volatile digital storage elements such as random access memory (RAM) and/or read only memory (ROM) or equivalents thereof. In particular, the processor/storage combinations provided in the base station controller 324 and mobile switching center 326 may be used to implement software algorithms stored in the storage devices 332, 342 and executed by the processor platforms 330, 340.

As shown, the base station controller 324 is coupled to a packet network 310 comprising an IWU 308. Likewise, the mobile switching center 326 is coupled to a circuit switch network 314 also comprising an IWU 312. As known in the art, an IWU enables communications between the devices to which they are coupled (e.g., a base station controller or mobile switching center) and a network. In alternate embodiments, the IWUs 308, 312 may be embodied in devices such as a packet data serving node (PDSN) or an access gateway, which devices are well known to those having ordinary skill in the art. Note that the base station controller 324 or mobile switching center are network elements capable of implementing the present invention. Finally, the IWUs 308, 312 residing in the packet and circuit switch networks may themselves be coupled to a public network 350 such as the Internet or World Wide Web.

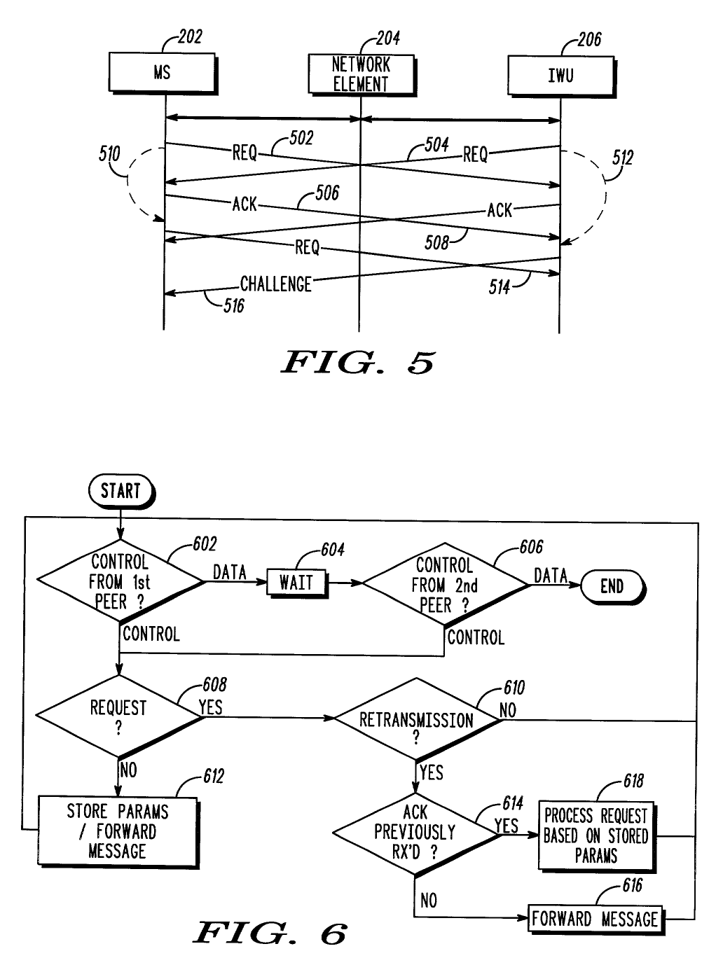

As described previously, the communication units 302 can establish communications with the IWUs 308, 312 via the intermediate network 306. To this end, a PPP comprising any peer to peer protocol requiring a two-way initialization may be used. The problems resulting from non-simultaneous link establishment and differing timeout timers and their effects on PPP establishment are further illustrated in FIGS. 4 and 5, respectively.

Referring now to FIG. 4, a timing diagram illustrating the problems arising from the occurrence of non-simultaneous link establishment is shown. (Note that in FIGS. 4, 5, 7 and 8, as in FIG. 4, the progression of time is indicated from top to bottom.) In particular, the communication unit 202 is attempting to establish a communication with the IWU 206 via the network element 204. However, the communication unit 202 has its link to the network element 204 established substantially after a link between the IWU 206 and the network element 204, as shown by the heavy arrows. Because the link between the IWU and network element is established well before the link between the communication unit and the network element, the IWU transmits a request 402 after its peer process has been initialized, which request 402 arrives at the communication unit shortly after link establishment for the communication unit. However, because the peer process in the communication unit 202 has not yet had a chance to initialize, the request message is ignored. Note that the IWU initiates a first timeout timer 408 awaiting the return of an acknowledgment in response to its transmitted request 402.

After the communication unit's peer process has been initialized, it transmits it own request message 404 to the IWU and, in return, the IWU transmits an acknowledgment 406 back to the communication unit. After receiving the IWU's acknowledgment 406, the communication unit initiates a second timeout timer 410 pending receipt of a configuration request from the IWU. Recall that the configuration request 402 originally sent by the IWU was ignored due to its early arrival at the communication unit. When the second timeout timer 410 expires, the communication unit assumes that it needs to restart the negotiation process and retransmits its configuration request 412. Likewise, upon expiration of the first timeout timer 408, the IWU retransmits its configuration request 414. This time, each request is acknowledged 416, 418 thereby concluding the negotiation handshake and allowing call setup to continue. However, additional negotiations required by the retransmissions of the configuration requests 412, 414 and the subsequent acknowledgments 416, 418 has substantially delayed the call setup. Depending on the stage of negotiation, such delays can be on the order of several milliseconds up to a few seconds, e.g., 100 msec.-2 sec.

Referring now to FIG. 5, a timing diagram illustrating the problems arising from the occurrence of different timeout timer durations at the separate peers is shown. In this case, the links between the communication unit 202, IWU 206 and network element 204 are established substantially simultaneously, as shown. Likewise, once peer processes have been initialized in both the communication unit and IWU, configuration requests 502, 504 are transmitted by each peer to the other. Likewise, configuration acknowledgments 506, 508 are subsequently transmitted in response to the respective requests 502, 504. However, in this case, the acknowledgment 508 sent by the IWU takes somewhat longer to transmit relative to the acknowledgment 506 transmitted by the communication unit. A variety of reasons, such as latency, retransmission of lower layers due to radio frequency loss, and processing delays may contribute to the greater delay by the IWU in transmitting the acknowledgment.

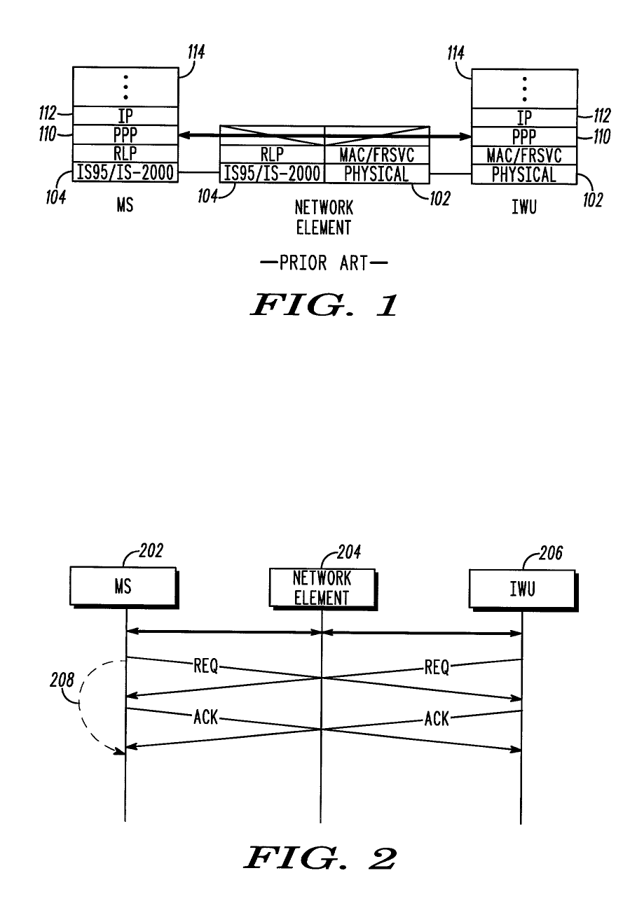

Regardless, each peer, upon transmitting its corresponding configuration request 502, 504 also initiates a timeout timer by which it awaits response of a configuration acknowledgment. However, in this case, the duration of the first timeout timer 510 in the communication unit is shorter than the duration of the second timeout timer 512 in the IWU. This leads to the acknowledgment 506 transmitted by the communication unit being received by the IWU prior to expiration of the second timeout timer. As a result, the peer process within the IWU assumes that the initial link control phase of PPP has been successfully initialized, and begins the authorization phase by issuing an appropriate challenge 516. However, the shorter duration of the first timeout timer 510 results in the acknowledgment 508 sent by the IWU arriving at the communication unit only after the first timeout timer 510 has expired, as shown. In response, the communication unit attempts to begin negotiations anew and retransmits its configuration request 514. As a result, at least one additional negotiation loop will be incurred before the PPP has been established, thereby delaying call setup. Note that in both scenarios illustrated in FIGS. 4 and 5, the network element 204 merely send the control messages (i.e., the configuration request and acknowledgments) through to the respective peers in a transparent fashion. That is, the network element 204 has no knowledge of the contents of the control messages. This is illustrated in FIG. 1 where the PPP messages exchanged by the terminating protocol layers in the peers (communication unit and IWU) pass through the network element unchanged.

A flowchart of a method for preventing the problems illustrated in FIGS. 4 and 5 is illustrated in FIG. 6. The method illustrated in FIG. 6 is preferably implemented as software algorithms executed by a network element residing within the intermediate network. In a presently preferred embodiment, the process illustrated in FIG. 6 is carried out by a base site controller or mobile switching center as described above. The process illustrated in FIG. 6 detects when configuration requests are being retransmitted and, in response, takes an appropriate action in order to avoid further negotiation loops. Note that the method illustrated in FIG. 6 accommodates the possibility that the problems illustrated in FIGS. 4 and 5 may be originated relative to either peer.

Beginning at block 602, the network element monitors messages exchanged between peers to determine if a point to point protocol control message has been sent by a first peer, particularly control messages relating to the negotiation phase of a point to point protocol session by the first peer, e.g., configuration request. To this end, the network element, rather than transparently passing point to point protocol messages through to their destinations, instead inspects any messages including data destined for the PPP layer in a peer. In particular, the network element starts monitoring after the physical links (i.e., between an MS and IWU and network element) have been established. Thereafter, the network element inspect every packet that passes through it looking for packets that contain a PPP header indicating status as a control message or a data message. If a control message from the first peer is not detected at block 602, meaning instead that a data message was sent, processing continues at block 604 where the network element waits a configurable predetermined period of time, typically on the order of hundreds of milliseconds. The particular duration selected is preferably selected based on optimization measurements made during system configuration and setup. Regardless, after waiting, the network element determines, at block 606, whether a control message has been received from the second peer. If not, again implying that a data message was sent by the second peer to the first peer, it is assumed that a point to point protocol session has already been established between the peers and the process is terminated. In the context of the present invention, this means that any stored parameters (described below) are discarded and monitoring for control messages ceases until a new call is started.

If, however, a control message from the first peer is detected at block 602, processing continues at block 608 to determine if the control message is a point to point protocol configuration request. If the control message is not a configuration request, implying that it is an acknowledgment, processing continues at block 612 where the parameters included in the acknowledgment are stored and the acknowledgment is subsequently forwarded to its intended destination. In practice, the parameters in the acknowledgment identify the particular configuration request that it is acknowledging. Examples of suitable parameters included in a configuration request and acknowledgment include an identification, magic number, maximum receive unit, address field compression and IP address. Processing thereafter resumes at block 602 with the network element monitoring messages between the first and second peer for control messages.

If the control message is a configuration request, processing continues at block 610 where it is determined whether the configuration request is a retransmission of a previous configuration request. If not, implying that the configuration request is the first such request sent by the first peer, processing continues at step 602. The processing of those blocks identified by reference numerals 602-612 continues until it is determined that a session has already been established (for example, as determined by the transmission of data by both peers) or until configuration requests are retransmitted by either the first or second peer. If, at block 610, it is determined that the a retransmitted request has been received from either the first or second peer, processing continues at block 614 where it is determined if an acknowledgment corresponding to the retransmitted configuration request was previously acknowledged. If not, implying that the peer originating the retransmitted request is attempting to restart negotiations after failing to receive a configuration request from the other peer or start a new negotiation, processing continues at block 616 where the retransmitted request is forwarded to its intended destination.

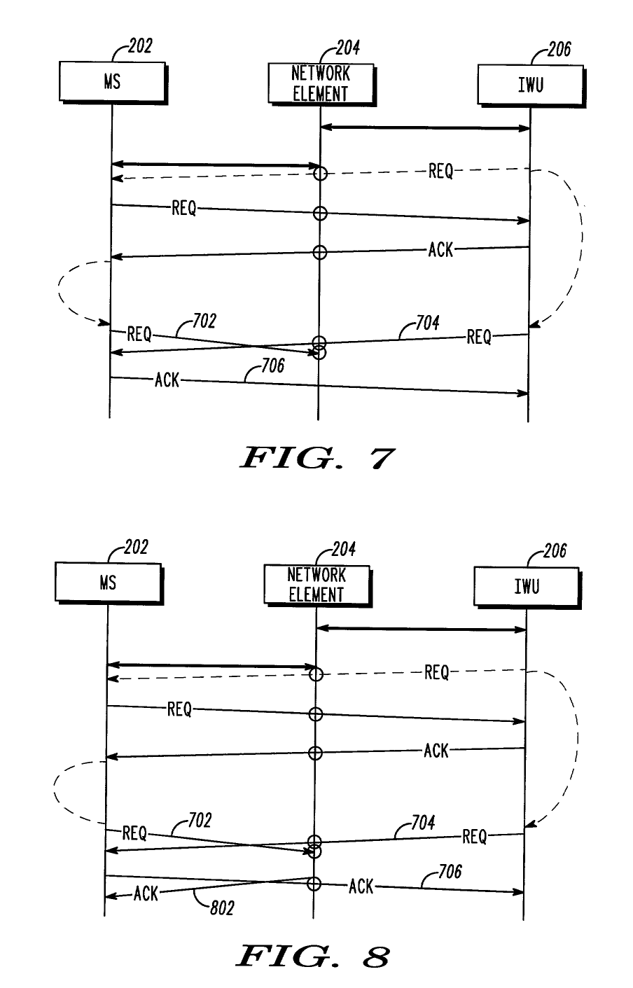

If, however, the previously received retransmitted request was acknowledged, processing continues at block 618 where the network element, rather than merely passing the retransmitted request through to its intended destination, instead processes the retransmitted request itself based on the parameters stored from the previously received acknowledgment. In a presently preferred embodiment, the network element, when processing a retransmitted configuration request, discards the retransmitted request, thereby preventing it from getting to its intended destination, and it may optionally (although, preferably) send an acknowledgment back to the sender of the retransmitted configuration request. In this manner, the network element is able to assure the sender of the retransmitted configuration request that the negotiation process has been successfully completed, thereby avoiding additional negotiation loops. This is further illustrated with respect to FIGS. 7 and 8.

As schematically indicated by the circles in FIGS. 7 and 8, a network element in accordance with the present invention monitors PPP messages sent between peers. Thus, in both FIGS. 7 and 8, the network element stores the parameters associated with the acknowledgment sent by the IWU 206 in response to the configuration request sent by the communication unit 202. Thereafter, it recognizes the retransmission 702 of the configuration request by the communication unit. In the scenario of FIG. 7, the non-preferred technique of simply discarding the retransmitted request 702 is illustrated. In this case, the IWU never receives the retransmitted request 702 because the network element determines that it had previously been acknowledged by the IWU. As a result, retransmits its own configuration request 704, which retransmitted request is passed on to the communication unit because it was not previously acknowledged. Thereafter, the retransmitted request 704 from the IWU is acknowledged 706 by the communication unit. In contrast, FIG. 8 illustrates the preferred embodiment in which an acknowledgment 802 is transmitted by the network element back to the sender of the retransmitted request, i.e., the communication unit. Generally, it is preferred to acknowledge the retransmitted request in order to cleanly terminate the handshake protocol from the point of view of the peer that has retransmitted the configuration request.

The present invention avoids duplicate negotiation loops or handshakes when establishing a PPP session in a wireless network. By monitoring messages exchanged between the two peers for control messages and storing relevant parameters, the present invention allows an intermediate network element to recognize the occurrence of retransmitted configuration requests that would lead to duplicate negotiations, and to process the retransmitted requests based on the stored parameters such that the occurrence of additional negotiation loops is avoided. In this manner, the effects of non-simultaneous link establishment and differing timeout timers are mitigated by the network element.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. In a communication system comprising at least two peers that communicate with each other across an intermediate network comprising at least one infrastructure element, a method for an infrastructure element of the at least one infrastructure element to establish communications between two peers of the at least two peers, the method comprising:
monitoring at least a portion of messages exchanged between the two peers for control messages;
storing at least some parameters corresponding to the control messages exchanged between the two peers to provide stored parameters;
detecting occurrence of retransmission of a control message from one of the two peers, wherein the retransmission of the control message will lead to duplicate negotiations between the two peers; and
processing the retransmission of the control message based on the stored parameters such that the duplicate negotiations are avoided.

2. The method of claim 1, wherein the control messages comprise point-to-point protocol control messages.

3. The method of claim 1, wherein the communication system comprises a wireless communication system, the at least two peers comprising at least one wireless communication unit in communication with at least one interworking unit via the intermediate network, and wherein the control message is sent from a wireless communication unit of the at least one wireless communication unit.

4. The method of claim 1, wherein the communication system comprises a wireless communication system, the at least two peers comprising at least one wireless communication unit in communication with at least one interworking unit via the intermediate network, and wherein the control message is sent from an interworking unit of the at least one interworking unit.

5. The method of claim 1, wherein processing of the retransmission of the control message further comprises discarding the retransmission of the control message.

6. The method of claim 1, wherein processing of the retransmission of the control message further comprises acknowledging the retransmission of the control message.

7. The method claim 1, further comprising, prior to detecting the retransmission of the control message:
detecting transmission of data by each of the two peers; and
discarding the stored parameters in response to detecting the transmission of data by each of the two peers.

8. A machine-readable medium having stored thereon machine-executable instructions for carrying out the method of claim 1.

9. In a communication system comprising at least two peers that communicate with each other across an intermediate network comprising at least one infrastructure element, a method for an infrastructure element of the at least one infrastructure element to establish communications between a first peer and a second peer of the at least two peers, the method comprising:
receiving, from the first peer, a request control message targeted to the second peer;
storing parameters from the request control message to provide stored request control message parameters;
forwarding the request control message to the second peer;
receiving, from the first peer, a retransmission of the request control message targeted to the second peer; and
processing the retransmission of the request control message based on the stored request control message parameters.

10. The method of claim 9, wherein the request control message and the retransmission of the request control message comprise point-to-point protocol control messages.

11. The method of claim 9, wherein processing of the retransmission of the control message further comprises discarding the retransmission of the control message.

12. The method of claim 9, wherein processing of the retransmission of the control message further comprises acknowledging the retransmission of the control message.

13. The method of claim 9, further comprising, prior to receiving the retransmission of the first request control message:
detecting transmission of data by each of the first peer and the second peer; and
discarding the stored request control message parameters in response to detecting the transmission of data by the first peer and the second peer.

14. A machine-readable medium having stored thereon machine-executable instructions for carrying out the method of claim 9.

15. An apparatus for use in an intermediate network forming a part of a communication system, the communication system comprising at least two peers that communicate with each other across the intermediate network, the apparatus comprising:
at least one processor; and
at least one storage device, coupled to the at least one processor, having stored thereon instructions that, when executed by the at least one processor, cause the at least one processor to:
monitor at least a portion of messages exchanged between two peers of the at least two peers for control messages;
store, in the at least one storage device, at least some parameters corresponding to the control messages exchanged between the two peers to provide stored parameters;
detect occurrence of retransmission of a control message from one of the two peers, wherein the retransmission of the control message will lead to duplicate negotiations between the two peers; and
process the retransmission of the control message based on the stored parameters such that the duplicate negotiations are avoided.

16. The apparatus of claim 15, wherein the control messages comprise point-to-point protocol control messages.

17. The apparatus of claim 15, wherein the at least one storage device further comprises instructions that, when executed by the at least one processor, cause the at least one processor to:
process the retransmission of the control message by discarding the retransmission of the control message.

18. The apparatus of claim 15, wherein the at least one storage device further comprises instructions that, when executed by the at least one processor, cause the at least one processor to:
process the retransmission of the control message by acknowledging the retransmission of the control message.

19. A base station controller embodying the apparatus of claim 15.

20. A mobile switching center embodying the apparatus of claim 15.
